(19) United States
(12) Patent Application Publication
(10) Pub. No.: US 2003/0104187 A1
(43) Pub. Date: Jun. 5, 2003

(54) Reflection preventing film

(75) Inventors: Mitsuhiro Nishida, Tokyo (JP); Yukihiro Kusano, Cambridge (GB); Nobuko Kato, Tokyo (JP)

Correspondence Address: KANESAKA AND TAKEUCHI, 1423 Powhatan Street, Alexandria, VA, 22314, US

(73) Assignee: BRIDGESTONE CORPORATION

(21) Appl. No.: 10/267,747

(22) Filed: Oct. 10, 2002

(30) Foreign Application Priority Data
Oct. 12, 2001 (JP) 2001-315612

(51) Int. Cl. B32B 7/02

(52) U.S. Cl. 428/212

(57) ABSTRACT

An anti-reflection film having quite a low reflectivity comprises a transparent substrate and first to N-th layers formed thereon, wherein, when the optical admittance of the interface between the N-th layer and (N-1)-th layer is represented by (x+iy), x and y satisfy the following inequality: 0.9×[(n²−n₀²)/2n₀^{]2}<[x−(n²+n₀²)/2n₀^{]2+y}²<1.1−[(n²−n₀²)/2n₀^{]2} wherein n₀ is the refractive index of the region outside the outermost layer (such as air or adhesive), and n is the refractive index of the outermost layer (the N-th layer).

### FIELD OF THE INVENTION

The present invention relates to an anti-reflection film to be used for display technology such as CRT screens and PDP screens.

### BACKGROUND OF THE INVENTION

Anti-reflection films comprise a plurality of layers comprising alternately laminated low-reflectivity layers and high-reflectivity layers on a transparent synthetic resin sheet. These anti-reflection films are mostly adhered to CRTs (cathode ray tubes) and PDPs (plasma display panels) with a transparent adhesive (including a self-adhesive agent). The anti-reflection film is adhered onto PDP or CRT in such a manner that the synthetic resin sheet faces the outside (the side away from CRT or PDP, that is, the side exposed to the atmosphere).

Simple methods for calculating the reflectivity and transmittance of the anti-reflection film comprising the multilayer film known in the art include a vector method, a Smith chart and a Kard chart.

For accurately calculating the reflectivity and transmittance of the multilayer film, characteristic matrices M₁, M₂, M₃, . . . , Mₖ determined by the complex refractive indices and optical thicknesses are defined for each layer, and the characteristic matrix M is determined from the product M₁, M₂, M₃, . . . , Mₖ. For designing the anti-reflection film, the refractive index and thickness of each layer are selected so that the desired reflectivity is obtained over a given wavelength range.

However, calculation of the characteristic matrix is very complicated and the optimum value cannot always be obtained.

### SUMMARY OF THE INVENTION

The anti-reflection film according to the present invention comprises a transparent substrate and a plurality of thin layers formed on the transparent substrate, and the outermost layer most remote from the transparent substrate is also transparent. When the optical admittance of the layer one layer closer to the transparent substrate side from the outermost layer is represented by (x+iy), x and y satisfy the following inequalities:

0.9×[(n²−n₀²)/2n₀^{]2}<[x−(n²+n₀²)/2n₀^{]2}+y²<1.1×[(n²−n₀²)/2n₀^{]2} wherein n₀ is the refractive index in the region outside the outermost layer, and n is the refractive index of the outermost layer.

Since the optical admittance at the interface between the outermost layer and the layer one layer closer to the transparent substrate side from the outermost layer falls within a prescribed range in the anti-reflection film according to the present invention, the anti-reflection film can be endowed with desired anti-reflection characteristics by properly selecting the refractive index and thickness of the transparent outermost layer.

### BRIEF DESCRIPTION OF THE DRAWINGS

FIG. 1 is a schematic cross section of the anti-reflection film according to the present invention.

FIG. 2 shows an orbit on a complex plane traced by the optical admittance Y (Y=x+iy) at the interface between the outermost layer and the layer just before the outermost layer.

FIG. 3 shows the region where the optical admittance Y (Y=x+iy) at the interface between the outermost layer and the layer just before the outermost layer is drawn on the complex plane.

### DETAILED DESCRIPTION

The anti-reflection film according to the present invention comprises a transparent substrate and a plurality of thin layers formed on the transparent substrate, and the outermost layer most remote from the transparent substrate is also transparent.

It is desirable that the transparent substrate have an attenuation constant k of substantially zero in the visible range.

The transparent substrate is desirably made of a synthetic resin sheet, in particular, a polyester film with a thickness of about 30 to 300 μm such as a polyethylene terephthalate (PET) film.

It is preferable that the number N of the thin layers formed on the transparent substrate is 2 to 10, and more preferably, 3 to 5.

Preferably, the first layer on the transparent substrate is a hard coat layer for protecting the synthetic resin layer. The first layer preferably has a thickness of about 2 to 20 μm.

The thickness of the layers from the second layer through the (N-2)-th layer is not particularly restricted when N is 4 or larger. Each layer has a different refractive index from that of the adjoining layers. Preferably, the layers from the second layer through the (N-2)-th layer comprise transparent synthetic resins such as acrylic resin or methacrylic resin.

The layer one layer closer to the transparent substrate side from the outermost layer desirably has an attenuation coefficient k of larger than 0.001, in particular, larger than 0.01 and smaller than 10. Examples of suitable layers having such an attenuation coefficient include a layer comprising a composite material containing fine particles of a metal, metal oxide, or metal nitride, for example, a composite layer of a transparent synthetic resin and fine particles of a metal, metal oxide, or metal nitride; or a thin layer of metal, metal oxide, or metal nitride. The thin layer is preferably deposited by a PVD (physical vapor deposition) method, particularly by vacuum vapor deposition or sputtering. The suitable thickness of the adjoining layers formed by the PVD method is 30 nm or less, and in particular, about 1 to 10 nm.

Examples of suitable metals include Au, Pt, Ag, Ti, Zn, Cu, Al, Cr, Co, Ni, C, Si, B, Ge, Zr, Nb, Mo, Pd, Cd, In and Sn, and suitable oxides and nitrides include those of Ag, Ti, Zn, Cu, Al, Cr, Co, Ni, C, Si, B, Ge, Zr, Nb, Mo, Pd, Cd, In and Sn.

It is desirable that the anti-reflection film has an anti-electrification function (with a specific resistivity of 5×10¹² Ω/□ or less). It is particularly desirable that the minimum reflectivity is 0.5% or less, the luminosity reflectivity is 1% or less, the specific resistivity is 10⁷ Ω/□ or less, and the transmittance is 60% or more. The specific resistivity of the anti-reflection film may be reduced and the anti-electrification function may be improved by using fine particles of a metal, conductive metal oxide, or metal nitride for the layer one layer closer to the transparent substrate from the outermost layer.

The outermost layer is selected so as to be transparent to visible light, or alternatively, absorption of the visible light by the outermost layer is preferably so small that it can be neglected. The preferable materials for the outermost layer are acrylic resins or methacrylic resins. The outermost layer may contain a transparent filler such as silica and MgF.

While the outside of the outermost layer is usually the atmosphere, it may be an adhesive. The adhesive adheres the anti-reflection film on a transparent panel such as a glass plate.

Details of the present invention will be described below with reference to the drawings.

The optical admittance Y is defined by the ratio (Y=H/E) of the magnetic field component H to the electric field component E of the light wave. When the light wave is a progressive wave progressing in a single layer having a refractive index of nₛ the following relation between the refractive index nₛ and optical admittance Y of the layer is valid:

$$Y = \frac{1}{{( {ϵ}_{0} / {μ}_{0} )}^{1 / 2}} {n}_{s} \qquad ( 1 )$$

wherein ε₀ and μ₀ are the dielectric constant and the magnetic permeability in vacuum, respectively.

Since the light velocity and magnetic permeability in vacuum are customarily used as units in the electromagnetic system, the optical admittance Y is equal to the refractive index nₛ of the medium as shown by the following equation:

Y=nₛ (2)

While the case where the light wave travels in a single layer has been described above, a part of the progressive wave returns in the direction opposite to the direction of the progressive wave after being reflected at the interface between individual layers when the light wave travels in the thickness direction of the laminated film comprising a plurality of thin layers having different refractive indices on the substrate (the wave returning in the opposite direction to the traveling direction is referred to as a returning wave hereinafter). Therefore, the light wave in each layer is represented by a combined wave of the progressive wave and returning wave returning by reflection at the plural interfaces. Accordingly, the electric field component E and magnetic field component H of the light wave (combined wave) in each layer are different from those of the progressive wave alone. As a result, the optical admittance Y, which is the ratio of the magnetic field to the electric field also changes, and the refractive index in each layer becomes different from the optical admittance Y.

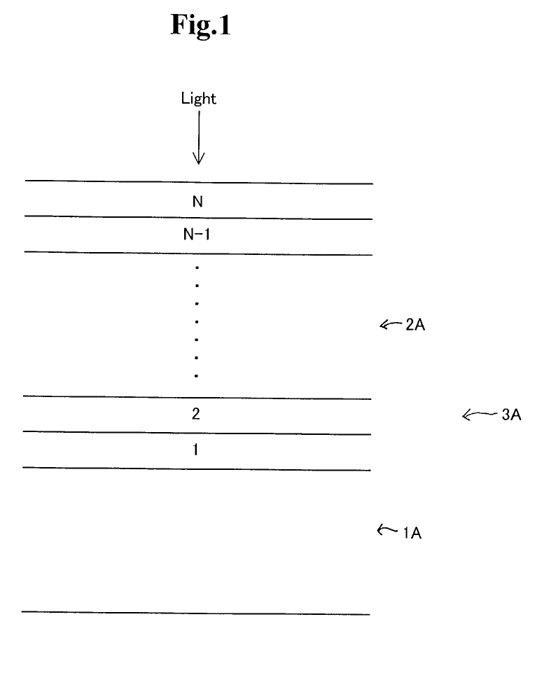

FIG. 1 is a schematic cross section of an anti-reflection film 3A The anti-reflection film 3A comprises a transparent substrate 1A and thin film layers 2A laminated on the transparent substrate 1A. The thin film layers 2A are composed of a first layer 1 in contact with the transparent substrate 1A, and second layer 2 to N-th layer N sequentially laminated thereon.

When light impinges on the film 3A through the N-th layer, the following relation is valid among Eₛ, Hₛ, E_{d}, and H_{d}, wherein E_{d} and Hₛ denote the electric field component and magnetic field component of the light, respectively, at the interface between the transparent substrate 1A and the first layer 1, and E_{d} and H_{d} denote the electric field component and magnetic field component of the light, respectively, at a position a distance d₁ away from the interface in the first layer 1:

$$( \begin{matrix}{E}_{d} \\ {H}_{d}\end{matrix} ) = ( \begin{matrix}cos {δ}_{1} & ( i / {n}_{1} ) sin {δ}_{1} \\ {in}_{1} sin {δ}_{1} & cos {δ}_{1}\end{matrix} ) ( \begin{matrix}{E}_{s} \\ {H}_{s}\end{matrix} ) \qquad ( 3 )$$

δ₁=2πn₁d₁/λ (4)

wherein i denotes the imaginary number unit, n₁ denotes the complex refractive index of the first layer, and λ denotes the wavelength of the incident light in vacuum.

Accordingly, from equation (3), the optical admittance Y_{d} at this position is represented by the following equation:

Y_{d}=H_{d}/E_{d}=(Yₛcos δ₁+in₁sin δ₁)/[cos δ₁+i(Yₛ/n₁) sin δ₁] (5)

where Yₛ denotes the optical admittance of the transparent substrate (Yₛ=Hₛ/Eₛ).

Equations (4) and (5) clearly show that the optical admittance Y_{d} in the first layer changes in accordance with the distance d₁ from the interface thereof. It is possible to calculate the optical admittance at an arbitrary point or surface within the N-th layer by successively performing similar operations with the proviso that the optical admittance is continuous.

The optical admittance Y at the interface between the outermost layer N and the layer (N-1) just before the outermost layer, and the optical admittance Yₑ at the outer point of the outermost layer (the interface between the outermost layer and the outside of the outermost layer (usually the atmosphere)) are represented by the following equations, respectively:

Y=x+iy (6)

Yₑ=xₑ+iyₑ (7)

When the outermost layer is considered to be transparent, or the refractive index of the outermost layer is represented only by a real number n, the optical admittance Y at the interface between the outermost layer N and the layer (N-1) just before the outermost layer is represented by the following equations:

$$\begin{matrix}x = \frac{{x}_{e}}{\{ 12 {x}_{e} \cdot tan \frac{δ}{n} + \frac{( {{x}_{e}}^{2} + {y}_{e}^{2} ) \cdot {tan}^{2} δ}{{n}^{2}} \} \cdot {cos}^{2} δ} & ( 8 ) \\ y = \frac{{y}_{e} ( 1 - {tan}^{2} δ ) - n ( 1 - \frac{{x}_{e}^{2} + {y}_{e}^{2}}{{n}^{2}} ) \cdot tan δ}{1 - \frac{2 {y}_{e} \cdot tan δ}{n} + \frac{( {x}_{e}^{2} + {y}_{e}^{2} ) \cdot {tan}^{2} δ}{{n}^{2}}} & ( 9 )\end{matrix}$$

where

δ=2πnd/λ₀ (10)

λ: wavelength of the incident light in vacuum

d: thickness of the outermost layer

The reflectivity R is represented as follows using the optical admittance Y₀(which is equal to the refractive index n₀ of the outer region) of the region outside the outermost layer N (usually air or adhesive) and the optical admittance Yₑ at the end point of the outermost layer (the interface between the outermost layer and the region outside the outermost layer):

$$R = \vert \frac{{Y}_{e} - {Y}_{o}}{{Y}_{e} + {Y}_{o}} {\vert}^{2}$$

Accordingly, the condition when the refractive index is zero is as follows:

Yₑ=xₑ+iyₑ=Y₀=n₀+i·0, or

xₐ=n₀, yₑ=0 (11)

The following relation is obtained by deleting δ by substituting equation (11) for equations (8) and (9) followed by rearrangement:

$${( x - \frac{{n}^{2} + {n}_{0}^{2}}{2 {n}_{0}^{2}} )}^{2} + {y}^{2} = {( \frac{{n}^{2} - {n}_{0}^{2}}{2 {n}_{0}} )}^{2} \qquad ( 12 )$$

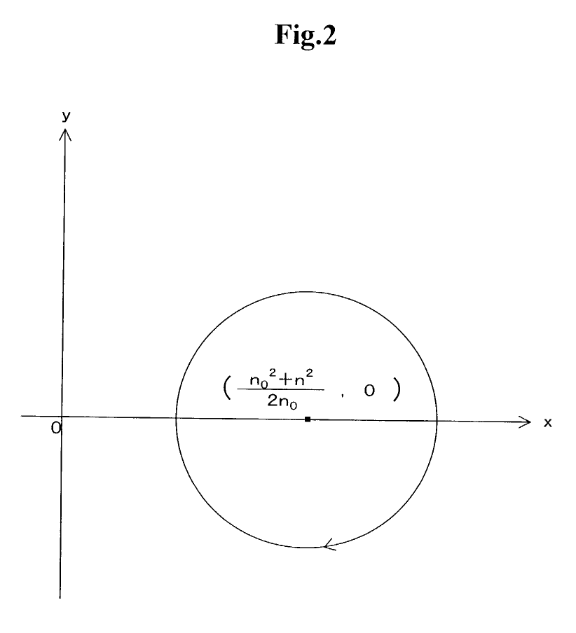

FIG. 2 shows an orbit of equation (12), or the orbit of the optical admittance Y=x+iy on the complex plane with a real axis of x and an imaginary axis y. As shown in FIG. 2, equation (12) shows a circular orbit with a radius of (n²−n₀²)/2n₀ around a central point ((n₀²+n²)/2n₀, 0), and the orbit moves clockwise as the thickness of the outermost layer increases. This equation means that the reflectivity at a wavelength of λ₀ may be reduced to zero by properly selecting the thickness d of the outermost layer, when the optical admittance Y at the interface between the outermost layer N and the layer (N-1) just before the outermost layer falls on a point on the circle represented by equation (12) on the complex plane.

Since conventional anti-reflection films have been designed so that the optical admittance Yₑ at the end point of the outermost layer is optimized, the calculation has been quite complicated due to the presence of a lot of unknown parameters. According to the present invention, on the other hand, it is possible to readily design an anti-reflection film with excellent anti-reflection characteristics by adjusting the refractive index and thickness of the layer (N-1) just before the outermost layer (this layer is called as an admittance adjusting layer hereinafter) so that the optical admittance falls on the circle represented by equation (12).

An anti-reflection film with a low reflectivity of almost zero can be obtained by allowing the optical admittance Y to fall within the range represented by the following inequalities, even when the optical admittance Y at the interface between the outermost layer N and the layer (N-1) just before the outermost layer does not fall on a point on the circumference of the circle.

0.9×[(n²−n₀²)/2n₀^{]2}

<[x−(n²+n₀²)/2n₀^{]2}+y²

<1.1×[(n²−n₀²)/2n₀^{]2} (13)

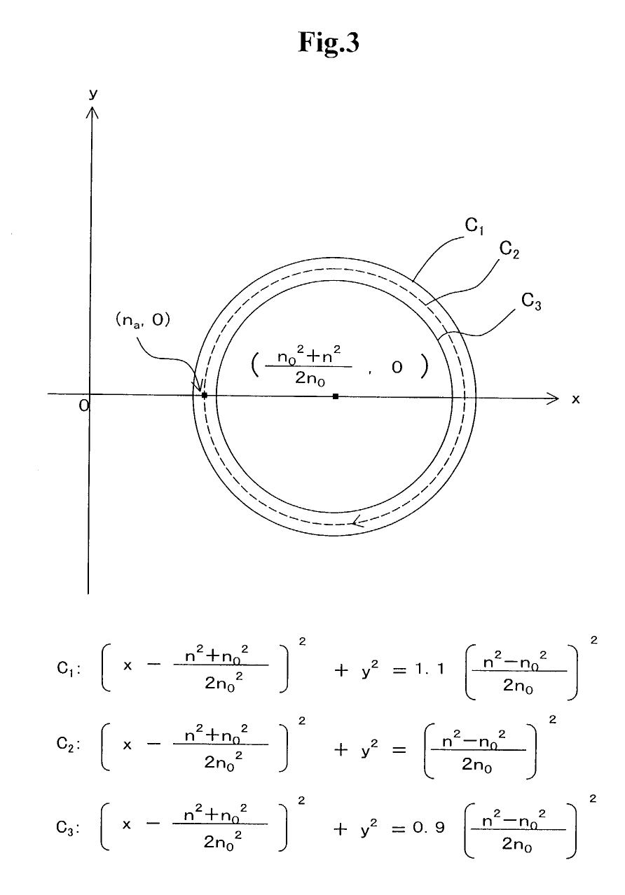

FIG. 3 shows the region on the complex plane indicating the relation represented by equation (13). As shown in FIG. 13, the optical admittance Y at the interface between the outermost layer N and the layer (N-1) just before the outermost layer may be designed so that it falls within a wide ring shaped region between the circles C₁ and C₃. Consequently, the design of the film may be simplified as compared with the conventional method by which the optical admittance Yₑ at the end point of the outermost layer is optimized.

The circles C₁, C₂ and C₃ are represented as follows:

$$\begin{matrix}{c}_{1} : {( x - \frac{{n}^{2} + {n}_{0}^{2}}{2 {n}_{0}^{2}} )}^{2} + {y}^{2} = 1.1 {( \frac{{n}^{2} - {n}_{0}^{2}}{2 {n}_{0}} )}^{2} \\ {c}_{2} : {( x - \frac{{n}^{2} + {n}_{0}^{2}}{2 {n}_{0}^{2}} )}^{2} + {y}^{2} = {( \frac{{n}^{2} - {n}_{0}^{2}}{2 {n}_{0}} )}^{2} \\ {c}_{3} : {( x - \frac{{n}^{2} + {n}_{0}^{2}}{2 {n}_{0}^{2}} )}^{2} + {y}^{2} = 0.9 {( \frac{{n}^{2} - {n}_{0}^{2}}{2 {n}_{0}} )}^{2}\end{matrix}$$

These equations clearly show that the circle C₂ is represented by the broken line in FIG. 3. The circle C₁ has a diameter of 1.1 times the diameter of the circle C₂, and the circle C₃ has a diameter of 0.9 times the diameter of the circle C2.

### EXAMPLES

While the present invention is described below with reference to examples and comparative examples, these examples are only illustrative, and the present invention is not restricted thereto.

### Example 1

A PET film with a thickness of 188 μm was employed as a transparent substrate. A first layer was formed by coating the transparent substrate with a hard coat material Z7501 commercially available from Nihon Synthetic Rubber Co. The first layer had an attenuation coefficient of zero and a refractive index of about 1.5.

A second layer of Ag with a thickness of 3.6 nm was deposited on the first layer by sputtering Ag thereon. The optical admittance Y at the interface between the second layer (Ag layer) and the outermost layer was represented as follows:

Y=x+iy=1.49−0−0.62i

A mixture of a polyfunctional acrylic resin and silica was coated on the second layer by photogravure, and the coated layer was cured by UV irradiation after drying to form a third layer (the outermost layer) with a thickness of 50 nm.

Since the outside of the third layer is air with a refractive index n₀ of 1.0 in Example 1, a value of A is calculated as follows:

A=[(n²⁻n₀²)/2n₀^{]2}

=[(1.51^{2-1.0}²)/(2×1.0)]²

=0.410

Values obtained by multiplying the above A value by 0.9 and 1.1 are 0.369 and 0.451, respectively.

The optical admittance Y between the outermost layer and the layer (Ag layer) just before the outermost layer is given as:

Y=x+iy=1.49−0.62i

Then, B is calculated as:

B=[x−(n²+n₀²)/2n₀^{]2}+y²

=[1.49−(1.51^{2+1.0}²)/2×1.0^{]2+}0.62²

=0.407

The value obtained above falls between the values obtained by multiplying A by 0.9 and 1.1, respectively.

The reflectivity of the anti-reflection film at a wavelength of 550 nm was 0.0%. The results are summarized in Table 1.

### Example 2

An anti-reflection film was manufactured by the same method as in Example 1, except that the second layer was formed as a gold sputtering film with a thickness of 5.9 nm, and the third layer (the outermost layer) was formed with a thickness of 54 nm. The optical admittance Y at the interface between the outermost layer and the layer (Au layer) just before the outermost layer was calculated as follows:

Y=x+iy=1.57−0.64i

The reflectivity of the anti-reflection film at a wavelength of 550 nm was 0.0%, as shown in Table 1. The values obtained by the same calculation in Example 1 are also shown in Table 1.

### Comparative Example 1

An anti-reflection film was manufactured by the same method as in Example 1, except that the second layer was formed as a silver sputtering layer with a thickness of 16.5 nm, and the third layer (the outermost layer) was formed with a thickness of 61 nm. The optical admittance Y at the interface between the outermost layer and the layer (Ag layer) just before the outermost layer was calculated as follows:

Y=x+iy=0.98−2.37i

The reflectivity of the anti-reflection film at a wavelength of 550 nm was 22.5%, as shown in Table 1. The values obtained by the same calculation in Example 1 are also shown in Table 1.

TABLE 1

| | | | thickness | | | | | | |
|---|---|---|---|---|---|---|---|---|---|
| | second layer | | of third | | A | | | B | reflectivlty |
| No. | material | thickness | layer | X + iY | (note) | 0.9A | 1.1A | (note) | (%) |
| Example 1 | Ag | 3.6 nm | 50 nm | 1.49 − 0.62 i | 0.410 | 0.369 | 0.451 | 0.407 | 0.0 |
| Example 2 | Au | 5.9 nm | 54 nm | 1.57 − 0.64 i | 0.410 | 0.369 | 0.451 | 0.415 | 0.0 |
| Comparative | Ag | 16.5 nm | 61 nm | 0.98 − 2.37 i | 0.410 | 0.369 | 0.451 | 6.053 | 22.5 |
| Example | | | | | | | | | |

notes:
A = [(n² − n₀²)/2n₀]²
B = [x − (n² + n₀²)/2n₀)² + y²

notes:

A=[(n²−n₀²)/2n₀^{]2}

B=[x−(n²+n₀²)/2n₀^{]2}+y²

As shown in the examples and comparative example, the present invention provides an anti-reflection film having quite a low reflectivity. The present invention is applicable to any arrangements equivalent to the following Claims.

What is claimed is:

1. An anti-reflection film comprising:
a transparent substrate; and
a plurality of thin layers formed on the transparent substrate, the outermost layer most remote from the transparent substrate being transparent,
wherein, when the optical admittance of the interface between the outermost layer and a layer one layer closer to the transparent substrate side from the outermost layer is represented by (x+iy), x and y satisfy the following inequalities:
0.9×[(n²−n₀²)/2n₀^{]2}<[x−(n²+n₀²)/2n₀^{]2}+y²<1.1×[(n²−n₀²)/2n₀^{]2}
wherein n₀ is the refractive index of the region outside the outermost layer, and n is the refractive index of the outermost layer.

2. The anti-reflection film according to claim 1, wherein the attenuation coefficient k of the outermost layer is zero.

3. The anti-reflection film according to claim 1, wherein the attenuation coefficient k of the layer one layer closer to the transparent substrate side from the outermost layer at a wavelength of 550 nm is larger than 0.001.

4. The anti-reflection film according to claim 1, wherein the attenuation coefficient k of the layer one layer closer to the transparent substrate side from the outermost layer at a wavelength of 550 nm is larger than 0.01 and smaller than 10.

5. The anti-reflection film according to claim 1, wherein the transparent substrate is a synthetic resin sheet.

6. The anti-reflection film according to claim 1, wherein the layer one layer closer to the transparent substrate side from the outermost layer comprises a composite material containing fine particles of a metal, metal oxide or metal nitride.

7. The anti-reflection film according to claim 1, wherein the layer by one layer closer to the transparent substrate side from the outermost layer comprises a thin film of a metal, metal oxide, or metal nitride.

8. The anti-reflection film according to claim 7, wherein the thickness of the layer one layer closer to the transparent substrate side from the outermost layer is 30 nm or less.

9. The anti-reflection film according to claim 5, wherein the synthetic resin sheet is a polyester film.

10. The anti-reflection film according to claim 5, wherein the synthetic resin sheet has a thickness of 30 to 300 μm.
